(19) United States
(12) Patent Application Publication
(10) Pub. No.: US 2019/0189119 A1
(43) Pub. Date: Jun. 20, 2019

(54) ELECTRONIC DEVICE

(71) Applicant: Onkyo Corporation, Osaka (JP)

(72) Inventor: Yusuke KONDO, Osaka (JP)

(21) Appl. No.: 16/213,209

(22) Filed: Dec. 7, 2018

(30) Foreign Application Priority Data
Dec. 15, 2017 (JP) 2017-240323

(51) Int. Cl. G10L 15/22

(52) U.S. Cl. CPC G10L 15/22; G10L 15/18; G10L 2015/223

(57) ABSTRACT

An electronic device comprising a controller, wherein the controller performs voice recognition, connects to a main assistant when a voice-recognized word is a predetermined word, and connects to a sub assistant when the voice-recognized word is a word other than the predetermined word.

### CROSS-REFERENCE TO RELATED APPLICATIONS

This application claims priority to Japanese Application No. 2017-240323, filed Dec. 15, 2017, the entire contents of which are incorporated herein by reference.

### FIELD

The present disclosure relates to an electronic device which performs voice recognition.

### BACKGROUND

There is an electronic device which includes a microphone and a speaker and has a function which receives operation of spoken voice from a user. FIG. 2 is a diagram illustrates a voice recognition system which includes the electronic device. The electronic device sends spoken voice of the user to an external server. The sever converts the spoken voice into text, and performs Natural Language Understanding (NLU). After NLU, the sever assigns the text to an appropriate command (domain), and executes an application which corresponds to the command. The electronic device connects to the external server on the application based on a demand from the user, and extracts appropriate information. For example, when the user speaks “What is today's weather in Osaka?”, the server extracts information of today's weather in Osaka as text data. The server converts the extracted text data, for example, text data of “Today's weather in Osaka is sunny” into audio, and sends it to the electronic device. The electronic device responds to the user's demand by outputting audio which is sent from the server from a speaker. In JP 2014-179067 A, an example that a user demands information of weather or destination (such as nearest restaurant) is illustrated.

In voice recognition, after audio data is converted into text, it is necessary to understand what intent is its content. For this reason, it is general to convert data into a command after Natural Language Understanding. Commanded event is sent to an application and is executed by the application. Hereinafter, an application is referred to as a domain. For example, an application which teaches weather to a user is referred to as a weather domain. When domains increase, the number of spoken voices and commands increases. There is a problem that contents of speaking and command are similar and erroneous recognition occurs depending on domains. As illustrated in FIG. 3, in a cooking domain (a domain which introduces recipes) and in a sight-seeing domain, “What is a special one?” and “What is a special sale?” are very similar, and they cannot be converted into a command. This problem always occurs when domains increase.

In conventional technology, as illustrated in FIG. 4, a problem of duplication of conversation is solved by firmly separating domains. FIG. 5 is a diagram illustrating a conventional voice recognition system. ASR (Autospeech recognition) recognizes a trigger word which starts voice recognition. For example, when a user speaks “Hello, Onkyo” and the ASR recognizes “Hello, Onkyo”, an assistant of latter stage operates. The assistant has various domains such as a music domain, a weather domain and so on, and speaking content and command are corresponding to each of domains.

When the user would like to call the cooking domain, the user speaks “Hello, Onkyo” and “Talk to chef”. When the assistant recognizes “Talk to chef”, hereafter, it monopolizes the cooking domain and ignores the command of the weather domain. The cooking domain is ended by time out in a state of no speaking or speaking which is intended to cancel from the user.

In conventional technology, it is redundant until the cooking domain is called.

### SUMMARY OF THE INVENTION

According to one aspect of the disclosure, there is provided an electronic device comprising a controller, wherein the controller performs voice recognition, connects to a main assistant when a voice-recognized word is a predetermined word, and connects to a sub assistant when the voice-recognized word is a word other than the predetermined word.

### BRIEF DESCRIPTION OF THE DRAWINGS

FIG. 1 is a block diagram illustrating a constitution of a voice recognition system according to an embodiment of the present disclosure.

FIG. 2 is a diagram illustrating a voice recognition system including an electronic device.

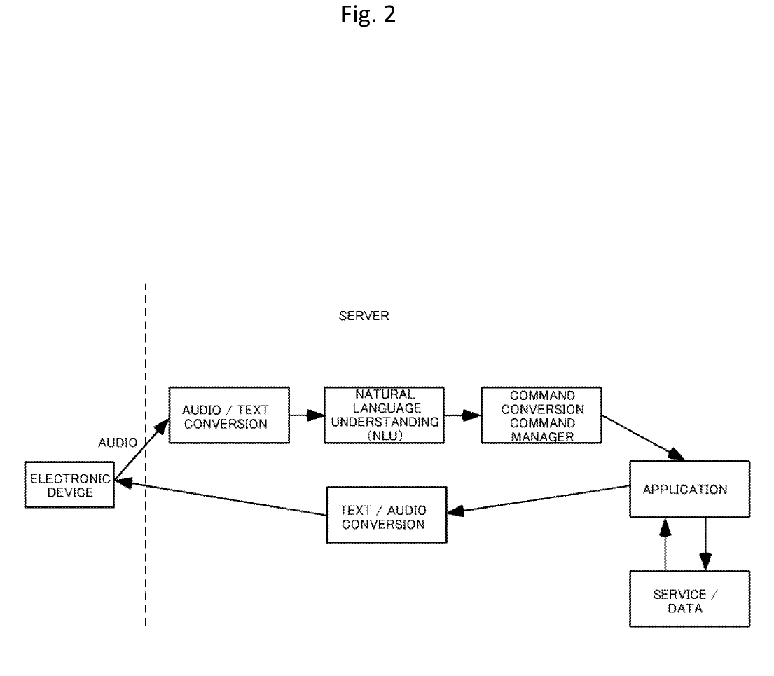

FIG. 3 is a diagram illustrating a case where conversations are similar between domains.

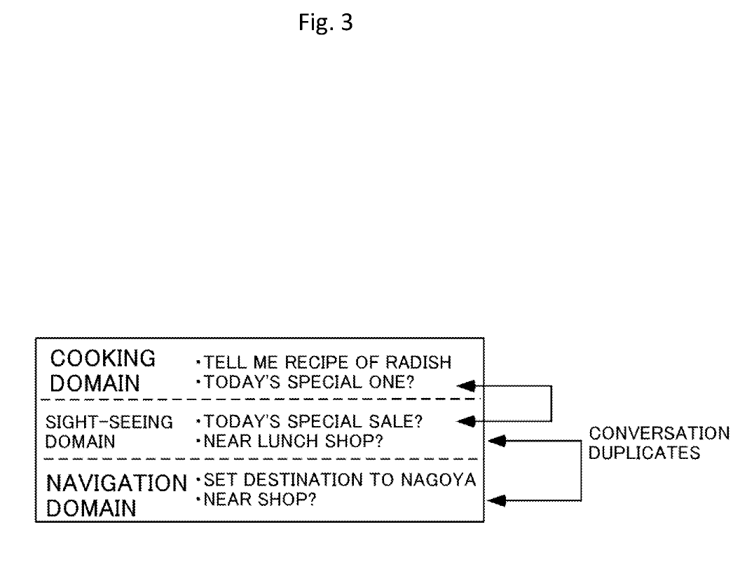

FIG. 4 is a diagram illustrating an example which separates conversation between domains.

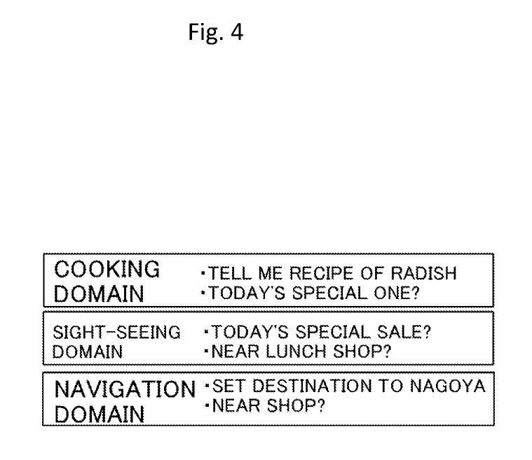

FIG. 5 is a diagram illustrating a conventional voice recognition system.

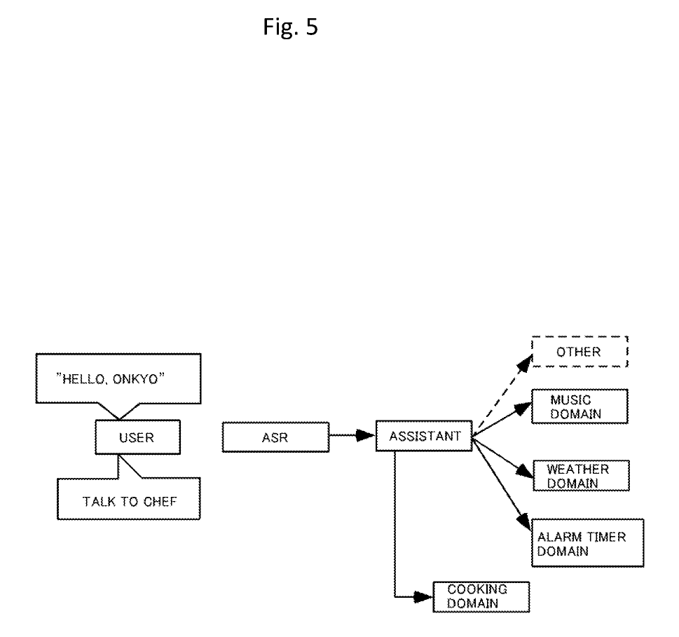

### DETAILED DESCRIPTION OF THE PREFERRED EMBODIMENTS

An objective of the present disclosure is to be able to call a predetermined domain simply.

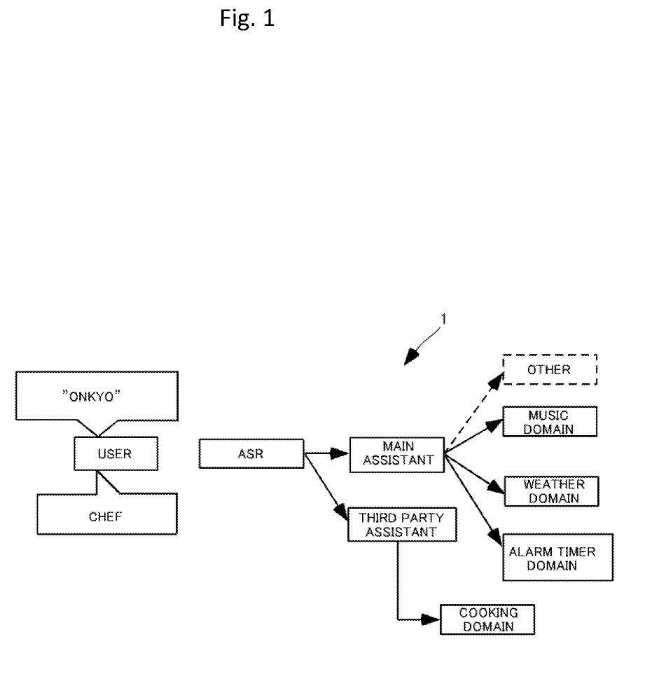

An embodiment of the present disclosure is described below. FIG. 1 is a block diagram illustrating a constitution of a voice recognition system according to the present embodiment. The voice recognition system 1 includes an electronic device and a cloud server. The electronic device includes an SoC (System on Chip) (controller), a microphone, and a speaker (not shown). The SoC performs recognition of voice which is input from the microphone (ASR (Auto Speech Recognition)), and connects to a main assistant or a third party assistant (sub assistant).

For example, when a voice-recognized word is “Onkyo” (predetermined word), the SoC connects to the main assistant. For example, “Onkyo” is so-called a trigger word for activating the assistant. A music domain, a weather domain and so on are corresponded to the main assistant. The main assistant connects to the music domain, the weather domain or the like based on content which is spoken by the user after “Onkyo”.

For example, when a voice-recognized word is “chef” (word other than the predetermined word), the SoC connects to the third party assistant. The third party assistant connects to a cooking domain which corresponds to “chef”, that is, a word related to cooking. In this manner, in ASR, the assistant to be connected is branched, and a predetermined domain can be used by a shorter trigger word than in conventional technology.

As described above, in the present embodiment, when a voice-recognized word is a word (for example, “chef”) other than a predetermined word (for example, “Onkyo”), the SoC connects to the sub assistant. The sub assistant connects to a domain (for example, the cooking domain) which corresponds to the word other the predetermined word. Thus, for example, the user can use the cooking domain by only speaking “chef”. For this reason, redundant call can be omitted. In this manner, according to the present embodiment, a predetermined domain can be called simply.

The embodiment of the present disclosure is described above, but the mode to which the present disclosure is applicable is not limited to the above embodiment and can be suitably varied without departing from the scope of the present disclosure.

The present dislcosure can be suitably employed in an electronic device which performs voice recognition.

What is claimed is:

1. An electronic device comprising a controller,
wherein the controller
performs voice recognition,
connects to a main assistant when a voice-recognized word is a predetermined word,
and connects to a sub assistant when the voice-recognized word is a word other than the predetermined word.

2. The electronic device according to claim 1,
wherein the sub assistant connects to a domain which corresponds to the word other than the predetermined word.

3. The electronic device according to claim 1,
wherein predetermined domains are corresponded to the main assistant and the sub assistant respectively.

4. A storage medium in which a control program of an electronic device which includes a controller is stored, the control program allows the controller:
to perform voice recognition;
to connect to a main assistant when a voice-recognized word is a predetermined word; and
to connect to a sub assistant when the voice-recognized word is a word other than the predetermined word.
